(19) United States
(12) Patent Application Publication
(10) Pub. No.: US 2004/0236658 A1
(43) Pub. Date: Nov. 25, 2004

(54) Computerized process for measuring the value or performance of an organization or intangible asset

(76) Inventor: Clement W. Bowman, Sarnia (CA)

Correspondence Address: GREENBERG-TRAURIG, 1750 TYSONS BOULEVARD, 12TH FLOOR, MCLEAN, VA, 22102, US

(21) Appl. No.: 10/822,137

(22) Filed: Apr. 12, 2004

Related U.S. Application Data
(63) Continuation-in-part of application No. 09/240,053, filed on Jan. 29, 1999.

(51) Int. Cl. G06F 17/60

(52) U.S. Cl. 705/36

(57) ABSTRACT

A computerized process for measuring the value or performance of an organization or intangible asset provides a graphical illustration of the performance or value of an asset, preferably by (1) establishing first and second variables related to the value of the intangible asset of interest, (2) establishing a matrix of performance criteria (3) establishing a series of performance criteria statements for each performance area probative of the value of the first and second variables, (4) using a computer to calculate first and second total scores based upon the extent to which individual statements accurately describe the intangible asset of interest, (5) using a computer to generate a chart having a first axis relating to the first variable and a second axis relating to the second variable, (6) using a computer to plot a point on the chart, the point being located at coordinates corresponding to the first and second total scores, respectively, 7) repeating the above for underlying matrices, with each underlying matrix representing a cell in the original matrix of performance criteria, and (8) using the chart in making at least one decision regarding the value of said intangible asset of interest.

### PRIORITY CLAIM

This application is a continuation-in-part of U.S. patent application Ser. No. 09/240,053, filed Jan. 29, 1999, the entire disclosure of which is incorporated herein by reference.

### BACKGROUND OF THE INVENTION

1. Field of the Invention

The invention relates in general to processes used by consultants, analysts, and executives for evaluating intangible assets, and in particular to a system for providing a definitive measurement of the value or performance of a technology, an organization, or other intangible asset of interest.

2. Related Art

Systems have been known for producing a grid-type graphical representation of the relative value of two dependent variables. One example of such systems is known as the Risk Management Matrix, used by the Boston Consulting Group for portfolio analysis. The Risk Management Matrix uses “Relative Market Share” and “Growth” as the two axes on a four-quadrant grid. These terms represent cash generation and cash use, respectively, and thus two dependent variables are represented on the axes of the grid. Such analyses are discussed in detail in “A Manager's Guide to Technology Forecasting and Strategic Analysis Methods,” Stephen M. Millet and Edward J. Honton, Batelle Press, 1991, which is incorporated herein by reference. Further, methods of analysis such as the Risk Management Matrix are qualitative, and the grid axes are normally not scaled. Thus, the position of an intangible asset on such grids is not subject to quantitative analysis. As a result of all of the above, such systems produce a grid which is largely judgmental and arbitrary.

Another known system of analysis is the Blake Managerial Grid, discussed in detail in “The Managerial Grid,” Robert R. Blake and Jane Mouton, Gulf Publishing Company, Library of Congress Number 64-14724, 1964, which is incorporated herein by reference. This grid is used to display different management styles, with one axis representing a concern for production and the other representing a concern for people. Different positions on the grid are used to represent different management approaches, ranging from autocratic to highly permissive. However, The Blake Managerial Grid, like the Risk Management Matrix, results in a positioning which is not arrived at through any disciplined procedure, is not subject to quantitative analysis, and is largely judgmental and arbitrary.

### SUMMARY OF THE INVENTION

It is therefore an object of the invention to provide an improved system for measuring the value or performance of a technology, an organization, or other intangible asset of interest.

It is a further object of the invention to provide a computerized system for generating a chart showing the performance or value of an intangible asset.

The process of the invention provides a graphical illustration of the performance or value of an asset by (1) establishing first and second variables related to the value of the intangible asset of interest, (2) establishing a matrix of performance areas, (3) establishing a series of performance criteria statements for each performance area probative of the value of the first and second variables, (4) using a computer to calculate first and second total scores based upon the extent to which individual statements accurately describe the intangible asset of interest, (5) using a computer to generate a chart having a first axis relating to the first variable and a second axis relating to the second variable, (6) using a computer to plot a point on the chart, the point being located at coordinates corresponding to the first and second total scores, respectively, and (7) using the chart in making at least one decision regarding the value of said intangible asset of interest.

The process of the invention according to a preferred embodiment provides a valuation grid which can be a means for performing, e.g., a quantitative comparison of organizations of a given class, a comparative analysis of various technological assets for venture capital pools, or a quantitative positioning of the level of achievement of an organization with respect to the vision and mission established by its owners.

A method of the present invention manufactures a chart reflecting the value of an intangible asset of interest, comprising the steps of establishing a first independent variable, a second independent variable, and a third independent variable related to the value of the specific intangible asset of interest; establishing a matrix of performance areas; establishing a series of performance criteria statements for each performance area probative of the value of the first, second, and third independent variables; scoring each of said performance criteria statements to produce a plurality of scores which reflect the applicability of the performance criteria statements to the specific intangible asset of interest; storing the plurality of scores obtained by the scoring step in an electronic database; using a computing apparatus to read and sum the stored plurality of scores to generate first, second, and third total scores based upon the extent to which individual statements accurately describe the intangible asset of interest; using a printer to transform physical media into a chart by physically plotting on the media a first axis relating to the first independent variable, a second axis relating to the second independent variable, and a third axis relating to the third independent variable; using a printer to physically plot a point on the chart, the point being located at coordinates corresponding to the first, second, and third total scores, respectively; and, using the chart in making at least one decision regarding the value of the intangible asset of interest. The first independent variable may relate to commercial strength, the second independent variable may relate to technical strength, and the third independent variable may relate to societal acceptability.

Another method of the present invention manufactures a chart reflecting the value of an intangible asset of interest, comprising the steps of establishing a first independent variable and a second independent variable related to the value of the specific intangible asset of interest; establishing a matrix of performance areas, comprising the steps of establishing three columns in the matrix, wherein a first column comprises performance areas regarding internal factors, a third column comprises performance areas regarding external factors, and a second column comprises performance areas that link the internal and external factors; establishing a series of performance criteria statements for each performance area probative of the value of the first and second independent variables; scoring each of said performance criteria statements to produce a plurality of scores which reflect the applicability of the performance criteria statements to the specific intangible asset of interest; storing the plurality of scores obtained by the scoring step in an electronic database; using a computing apparatus to read and sum the stored plurality of scores to generate first and second total scores based upon the extent to which individual statements accurately describe the intangible asset of interest; using a printer to transform physical media into a chart by physically plotting on the media a first axis relating to the first independent variable and a second axis relating to the second independent variable; using a printer to physically plot a point on the chart, the point being located at coordinates corresponding to the first and second total scores, respectively; and, using the chart in making at least one decision regarding the value of the intangible asset of interest.

Another method of the present invention manufactures a chart for determining the future value of an intangible asset of interest, comprising the steps of establishing a first independent variable and a second independent variable related to the value of the specific intangible asset of interest; establishing a matrix of performance areas; establishing a series of performance criteria statements for each performance area probative of the value of the first and second independent variables; scoring each of said performance criteria statements to produce a plurality of scores which reflect the applicability of the performance criteria statements to the specific intangible asset of interest; storing the plurality of scores obtained by the scoring step in an electronic database; using a computing apparatus to read and sum the stored plurality of scores to generate first and second total scores based upon the extent to which individual statements accurately describe the intangible asset of interest; using a printer to transform physical media into a chart by physically plotting on the media a first axis relating to the first independent variable and a second axis relating to the second independent variable; using a printer to physically plot a point on the chart, the point being located at coordinates corresponding to the first and second total scores, respectively; determining values for a code having a first value, a second value, and a third value, wherein the first value is the number of improvement steps the asset is likely to achieve if the current position is at a lowest performance level, the second value is the number of improvement steps the asset is likely to achieve if the current position is at a level higher than the lowest performance level, and the third value is the number of improvement steps the asset is likely to achieve if the current position is at two levels higher than the lowest performance level; determining a maximum performance rating by adding a performance rating value to the first value, second value, or third value of the code; calculating a x-coordinate, corresponding to the first axis, and a y-coordinate, corresponding to the second axis, of the future value utilizing the maximum performance rating; plotting the x and y coordinates of the future value on the chart. The values for the first value, second value, and third value may be held constant. A desired future value may be achieved through the occurrence of at least one of the following: the current development is completed, the fundamentals underlying the venture improve, the competitive position improves, and the business factors improve; wherein each occurrence requires a code having a first value, second value, and third value. The future value may be plotted representing an improvement or deterioration in at least one of the occurrences.

Another method of the present invention manufactures a chart reflecting the value of an intangible asset of interest, comprising the steps of establishing a first independent variable and a second independent variable related to the value of the specific intangible asset of interest; establishing a matrix of performance areas; establishing a series of performance criteria statements for each performance area probative of the value of the first and second independent variables; scoring each of said performance criteria statements to produce a plurality of scores which reflect the applicability of the performance criteria statements to the specific intangible asset of interest; storing the plurality of scores obtained by the scoring step in an electronic database; using a computing apparatus to read and sum the stored plurality of scores to generate first and second total scores based upon the extent to which individual statements accurately describe the intangible asset of interest; using a printer to transform physical media into a chart by physically plotting on the media a first axis relating to the first independent variable and a second axis relating to the second independent variable; using a printer to physically plot a point on the chart, the point being located at coordinates corresponding to the first and second total scores, respectively; and, using the chart in making at least one decision regarding the value of the intangible asset of interest. Further steps may include establishing an underlying matrix of performance areas for each cell in the matrix of performance areas; establishing primary and secondary independent variables related to the value of a cell in the matrix of performance areas; establishing a series of underlying matrix performance criteria statements for each underlying matrix performance area probative of the value of the primary and secondary independent variables; scoring each of the underlying matrix performance criteria statements to produce a plurality of underlying scores which reflect the applicability of the performance criteria statements to the specific intangible asset of interest; storing the plurality of underlying scores obtained by said scoring step in an electronic database; using a computing apparatus to read and sum the stored plurality of underlying scores to generate primary and secondary total scores based upon the extent to which individual statements accurately describe said intangible asset of interest; using a printer to transform physical media into a chart by physically plotting on the media a primary axis relating to the primary variable and a secondary axis relating to the secondary variable; using a printer to physically plot a point on said chart, said point being located at coordinates corresponding to the primary and secondary total scores, respectively; and, comparing the underlying matrix with the related performance area in the matrix. The cells of the underlying matrix may have a second underlying matrix, such that performance of the upper level matrix may be measured at the more detailed underlying matrices. The method may further include the steps of entering as data of least one assessment of the performance criteria; opening a calculator template; transferring the data to the calculator template, wherein the calculator template performs calculations on the data to create calculated data; transferring the calculated data from the calculator template to a report template; and creating a report file for the calculation data. The calculations may comprise summing of scores, applying axis weighting factors, or generating data describing a valuation grid and a point on the valuation grid. The report file may be saved.

### BRIEF DESCRIPTION OF THE DRAWINGS

The foregoing and other objects, features, and advantages of the invention will be apparent from the following more particular description of preferred embodiments as illustrated in the accompanying drawings. The drawings are not necessarily to scale, emphasis instead being placed upon illustrating principles of the invention.

FIG. 1(a) illustrates a matrix of performance areas reflecting the value or performance of a for-profit company.

FIG. 1(b) illustrates a matrix of performance areas reflecting the value or performance of a research and development organization.

FIG. 1(c) illustrates a matrix of performance areas reflecting the value or performance of a university.

FIG. 1(d) illustrates a matrix of performance areas reflecting the value of a technical asset.

FIG. 2 illustrates five examples of performance criteria for cell B2 of the matrix shown in FIG. 1(d).

FIG. 3 illustrates a performance criteria scoring form.

FIG. 4(a) and (b) illustrate valuation grids produced according to the process of the invention.

FIG. 5 illustrates a series of intangible assets ranked by their position on a valuation grid.

FIG. 6 is a graphical representation of performance area scores created according to the system of the invention.

FIG. 7 is a screenshot showing an example of a user input page for data collection according to the invention.

FIG. 8(a) illustrates a computer process to provide for the entry of evaluation data, the performance of evaluation calculations and automatic production of reports of the value of an intangible asset.

FIG. 8(b) is a screenshot of a user input page for the evaluation of a new gasoline additive.

FIG. 8(c) is a screenshot of three sets of performance areas, each with four statements defining different performance levels.

FIG. 8(d) is a screenshot of an output chart which defines the position of an intangible asset with respect to the two independent variables, compared to other intangible assets of a similar class.

FIG. 9 shows a table illustrating the results of a computer calculation of the evaluation of a technology for treating mineral ores to improve their separation.

FIG. 10 shows a computer-generated chart illustrating a valuation grid with current and future chart positions.

FIG. 11 shows a computer-generated bar chart with current ratings for performance areas.

FIG. 12 shows a computer-generated bar chart with future ratings for performance areas.

FIG. 12(a) shows a computer-generated chart with four sets of upside future ratings and four sets of downside computer-generated ratings.

FIG. 13 shows a three-level set of cascading matrices.

FIG. 14 shows a computer-generated chart illustrating a valuation grid as measured by an upper level matrix.

FIG. 15 shows a computer-generated bar chart with performance area ratings as measured by an upper level matrix.

FIG. 16 shows a computer-generated chart illustrating a valuation grid as measured by a lower level matrix.

FIG. 17 shows a computer-generated chart comparing performance area ratings as measured by upper and lower level matrices.

FIG. 18 shows a table illustrating the results of a computer calculation for determining the upper level grid position based on lower level evaluations.

FIG. 19 shows the computer-generated chart determined by the calculation described in FIG. 18.

FIG. 20 shows the computer-generated chart illustrating the comparison of lower level valuation grids.

FIG. 21 shows a table illustrating the computer calculation for assigning chart positions for lower level grids with respect to the independent first and second variables.

FIG. 22 shows the computer-generated chart illustrating the comparison of lower level valuation grids with respect to the independent first and second variables.

FIG. 23 shows a table illustrating the results for the calculation of the value of technologies with respect to three independent variables.

FIG. 24 shows the computer-generated chart for evaluating technologies with respect to three independent variables.

### DETAILED DESCRIPTION OF THE INVENTION

The performance or value of an organization, technology, or other intangible asset can depend on, and be described in terms of, two or more independent variables. The first step in carrying out the process of the invention is to define at least two independent variables which best reflect such performance or value of the particular organization or asset under analysis. For example, the value of a particular technology or technical asset can be understood in terms of its commercial strength versus its technical strength; the value or position of a university can be understood in terms of its teaching excellence versus its research excellence; the value of a research and development organization can be described in terms of its R&D management capability versus its impact on corporate clients and the public; and, the value of a private sector company can be understood in terms of its organizational excellence versus the its business success business. The particular pair of independent variables, including but not limited to those pairs listed above, should be selected according to the type of organization or asset to be evaluated.

For purposes of illustrating the principles of the present invention, the embodiments described herein utilize two independent variables in implementing a valuation. In another embodiment, described herein in more detail below, an evaluation of an intangible asset involves three independent variables.

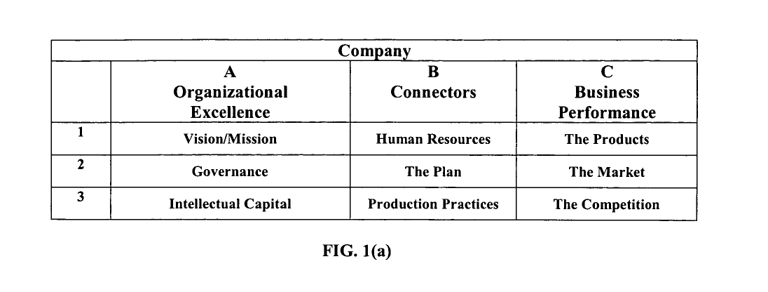

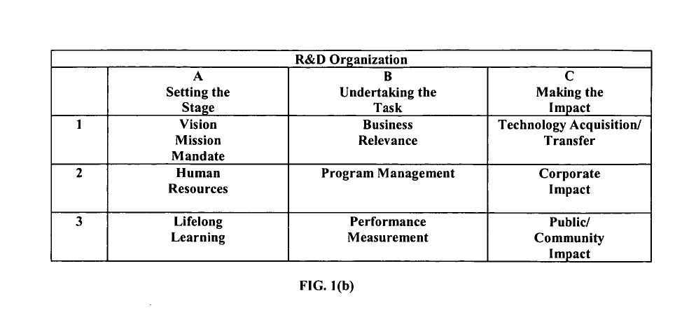

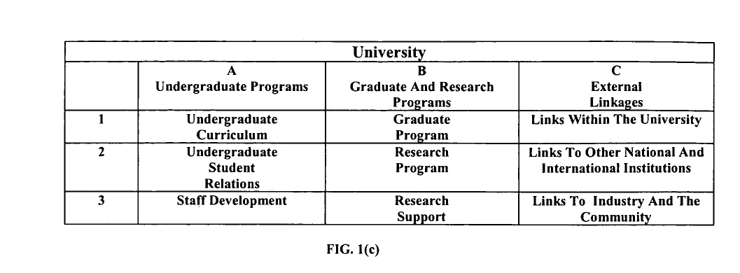

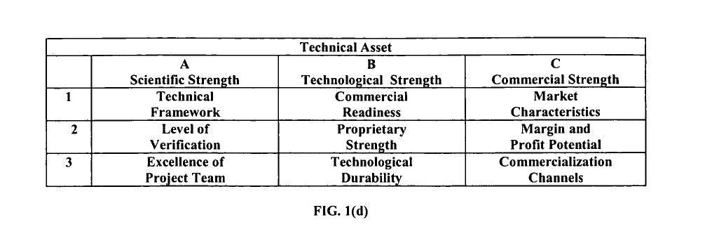

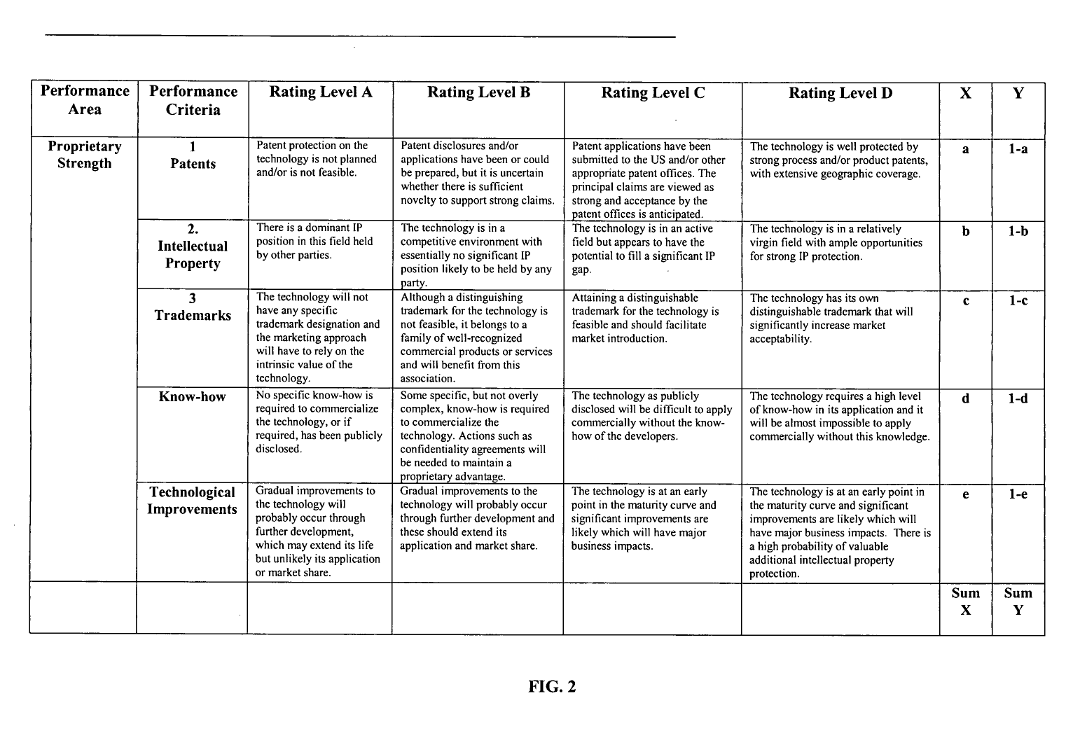

Once the first step of selecting at least two independent variables has been performed, the next step according to the process of the invention is to establish a series of performance areas and performance criteria statements probative of the value of the first and second variables. This preferably begins with creation of an array, or matrix, of performance areas, i.e., areas which are considered to be important in evaluating the organization or asset. Examples of performance matrices for various organizations and assets are shown in FIGS. 1(a)-1(d). It is convenient to establish these matrices in a three column format: the first column (A) includes performance areas related to internal factors (which can be considered as inputs), the third column (C) includes performance areas related to external factors (which can be considered as outputs or impacts), and the second column (B) includes performance areas which connect the internal and external factors. However, other matrix formats may be required for specific performance measurement tasks.

A number of performance criteria are then created for each cell in the performance matrix. FIG. 2 illustrates five performance criteria relating to the performance area in cell B2 (Proprietary Strength) of the performance matrix shown in FIG. 1(d). In this example, four performance statements are established for each performance criterion, with a rating value indicating different levels of strength relative to the performance area to which the criterion relates. As will be discussed in more detail below, the process of the invention according to a preferred embodiment includes a subsequent step in which an evaluator selects, from among the four statements for each of the criteria, the one statement which most accurately describes the organization or asset being assessed.

As illustrated in FIG. 2, all of the performance criteria relating to the “Proprietary Strength” performance area are grouped together; however, it may be preferable in some cases to scramble the criteria so that performance criteria relating to one performance area are interspersed with performance criteria relating to other performance areas. Such scrambling can avoid bias during the subsequent selection step.

The performance criteria can be defined by persons with extensive experience in the type of organization or asset being evaluated, or can be selected from a data base of previously-established matrices for similar organizations.

The performance statements preferably have rating levels and axis-weighting factors associated with them. With respect to rating levels, these are identified in FIG. 2 as rating levels A, B, C and D along the top row of the chart. At least one rating level is required for each performance criteria. It is necessary to assign numerical values to these rating levels. In the example shown in FIG. 2, statements which reflect a low degree of proprietary strength could be assigned a rating level of 0, statements which reflect a moderate degree of proprietary strength could be assigned a rating level of 1, statements which reflect a high degree of proprietary strength could be assigned a rating level of 2, and statements which reflect an outstanding degree of proprietary strength could be assigned a rating level of 3.

With respect to assignment of axis-weighting factors, this is necessary for accurately plotting the orthogonal relationship between the two independent variables selected above in step 1. Assignment of axis-weighting factors for each of the criteria serves to apportion the rating level of that criteria to the X-axis and Y-axis, respectively. The two right-hand columns, X and Y, in FIG. 2 illustrate assigned weighting factors. The preferred method of performing the assignment is to apportion the value of unity between the two axes; for example, assigning a weighting factor of 1.0 to the X-axis and a weighting factor of 0.0 to the Y-axis would indicate that the criteria contributed entirely to X-axis performance. Likewise, assigning 0.0 to the X-axis and 1.0 to the Y-axis would indicate that the criteria contributed entirely to Y-axis performance; and, assigning 0.5 to each of the axes would indicate that the contribution was equally divided between the two axes.

The third step is to undertake the assessment and calculate scores for each of the independent variables. An evaluator is given a complete set of forms similar to that shown in FIG. 2, but with criteria for each of the performance areas on the appropriate performance matrix, and he selects (e.g., by circling) for each of the criteria the one statement which best describes the organization or asset being evaluated. The assessment may be undertaken by a range of stakeholders, such as the staff of an organization at various organizational levels, the owners, key clients, or alliance partners.

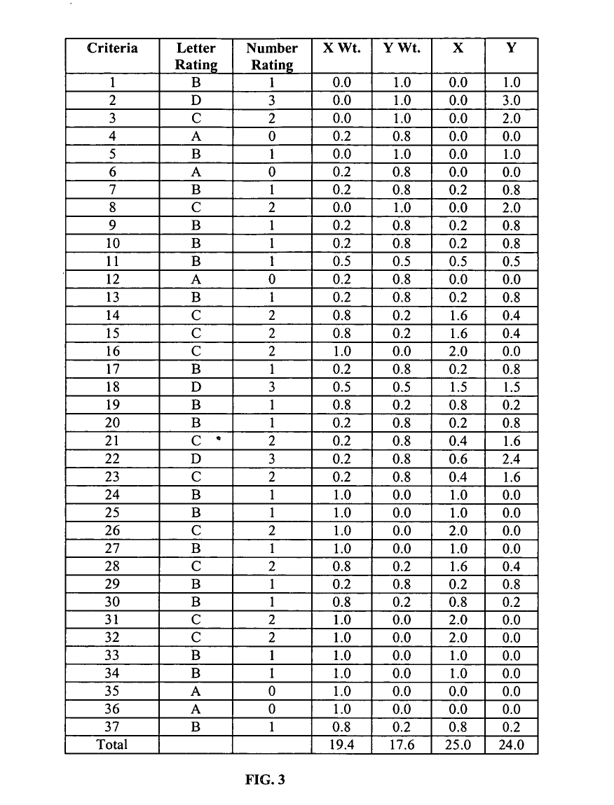

Once the assessment has been undertaken, the results are preferably compiled in a form as shown in FIG. 3. In the example of FIG. 3, there are 37 criteria for the nine performance areas shown in FIG. 1(d). In this particular example, a four-level rating was used, with a numerical rating of 0 assigned to statements which reflect the lowest performance in the corresponding performance area, a numerical rating of 1 assigned to statements which reflect a moderate performance in the performance area, a numerical rating of 2 assigned to statements which reflect a high performance in the performance area, and a numerical rating of 3 assigned to statements which reflect an outstanding performance in the performance area. In this example, the evaluators are requested to use letters A, B, C, and D to represent the four performance levels. The computer program converts these four letters to the corresponding numerical values. This procedure avoids disclosing the numerical values to the evaluators to further minimize bias.

For each criterion, the rating level of the statement selected is multiplied by the X-axis weight to obtain the X-axis contribution, and by the Y-axis weight to obtain the Y-axis contribution. The X-axis contributions are summed and the Y-axis contributions are summed; the resulting totals are shown at the bottom right of the form in FIG. 3. In the example of FIG. 3, the X total is 25.0 out of a maximum of 58.2 (19.4 multiplied by 3), and the Y total is 24.0 out of a maximum of 52.8 (17.6 multiplied by 3).

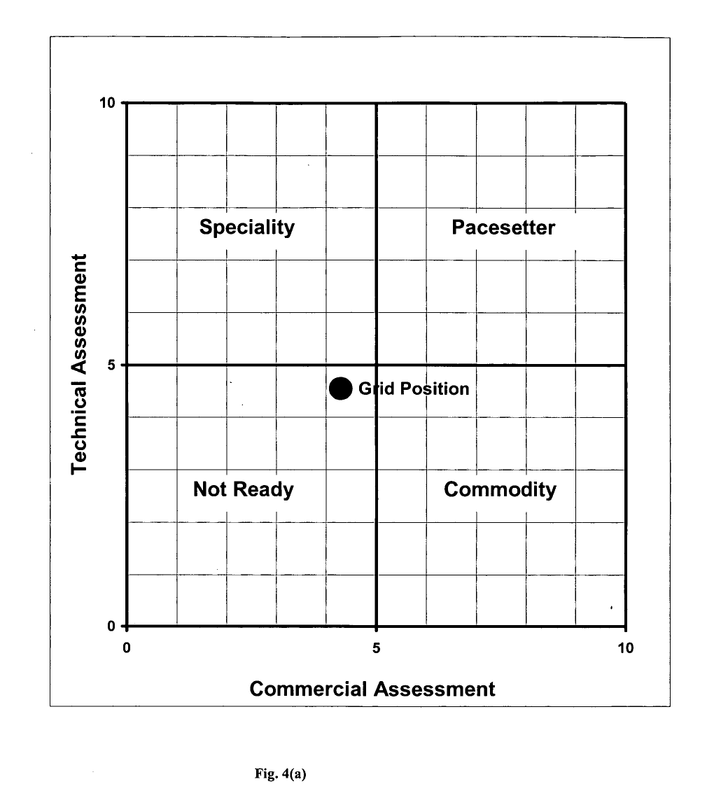

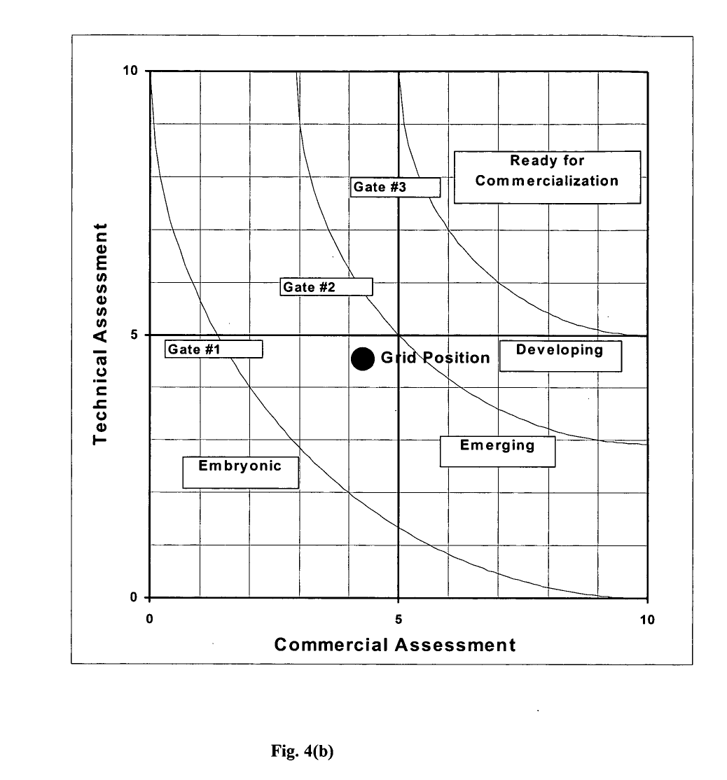

The fourth step is to plot the X-axis total and the Y-axis total on an evaluation grid, with the independent variables as axes. FIG. 4(a) illustrates such an evaluation grid resulting from application of the process of the invention to a technical asset. The grid shown in FIG. 4(a) comprises a ten-point scale; thus, the total values obtained above of 25.0 for the X-axis and 24.0 for the Y-axis correspond to plot positions of 4.3 (25.0 multiplied by 10 and divided by 58.2) and 4.5 (24.0 multiplied by 10 and divided by 52.8), respectively, on the grid.

To make the graphical illustration shown in FIG. 4(a) more meaningful, it is useful to assign names to each of the four quadrants in the evaluation grid. In FIG. 4(a), the quadrants are assigned the names “Specialty”, “Pacesetter”, “Commodity”, and “Not Ready”.

A valuation grid for a technology would show the positioning of the technology in one of the four quadrants, e.g., “Specialty” in an upper left quadrant, “Pacesetter” in an upper right quadrant, “Commodity” in a lower right quadrant, and “Not Ready” in a lower left quadrant. At the inception of a new idea, the technology may be considered to lie at the origin. As the idea matures into a bona fide technology, it will follow a trajectory through the “Not Ready” quadrant to one of the other three quadrants. If the technology follows a forty-five degree diagonal, this indicates that technical and market developments are proceeding in parallel. If the market develops faster than the technology, the trajectory will move into the “Commodity” quadrant; conversely, if technical progress proceeds faster than market development, the trajectory will move into the “Specialty” quadrant. The position in which the trajectory terminates determines the overall merits of the technology. The higher the trajectory proceeds into the “Pacesetter” quadrant, the more likely it is that there will be a high level of commercial success.

The four-quadrant grid is useful for obtaining an overall view of the status of a technology. However, a more insightful display of the status is shown in FIG. 4(b), in which the four-quadrant boundaries are replaced by three curves that are concentric with the point 10,10. Points that lie on one of these curves have different combinations of technical and commercial strength but have the same distance to “travel” to reach the upper right hand corner of the grid. With this display, zones between the curves can be described as “Embryonic”, “Emerging”, “Developing” and “Ready for Commercialization”. A factor “R” can be defined which is the progress a technology has achieved as it travels from inception (0,0) to fully developed (10,10). Mathematically this factor is equal to:

(SQRT(200)−SQRT((X−10)\hat{ }2+(Y−10)\hat{ }2))/SQRT(200)

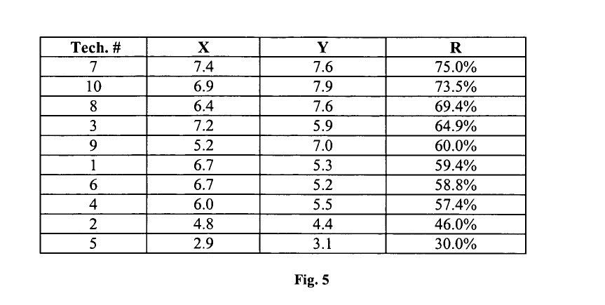

The R factor can be used to rank a set of technologies, or any other intangible asset, as shown in FIG. 5. Ten technologies which have different X, Y values and therefore different R values are compared and sorted.

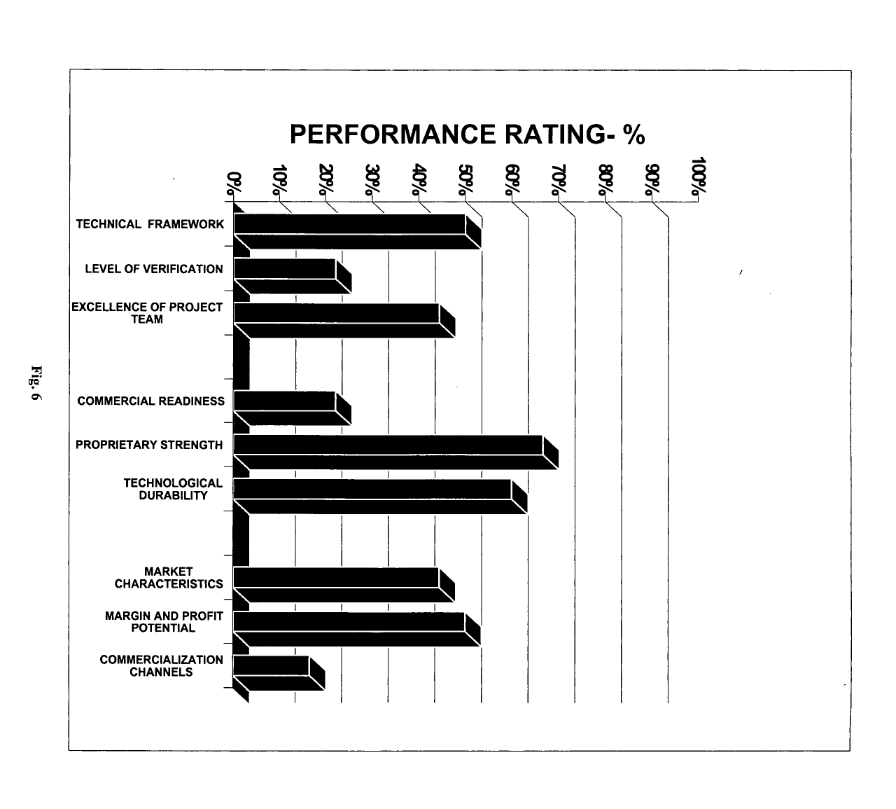

It is also useful to create a chart showing the scores for each of the performance areas. Such a chart is illustrated in FIG. 6. This step provides a more-detailed graphical representation of the information represented in the evaluation grid by identifying the specific strengths and weaknesses of the organization or asset being evaluated. If the performance criteria have been scrambled as described above with regard to the third step, it may be necessary to unscramble the criteria in order to obtain scores for each performance area.

The invention may be practiced by means of computer hardware and software. The following example shows a process that uses a computer program or programs for the evaluation of an actual technological asset of interest to a venture capital company, but it will be understood by those skilled in the art that the disclosed process could be applied to other evaluations, particularly those disclosed herein. The example below shows the complete process of the invention according to a preferred embodiment, including the initial steps of collecting and entering of data, the computer calculation, and the production of the charts. It also includes an application of the invention for determining the future value of the asset in addition to determination of an asset's present value as discussed above.

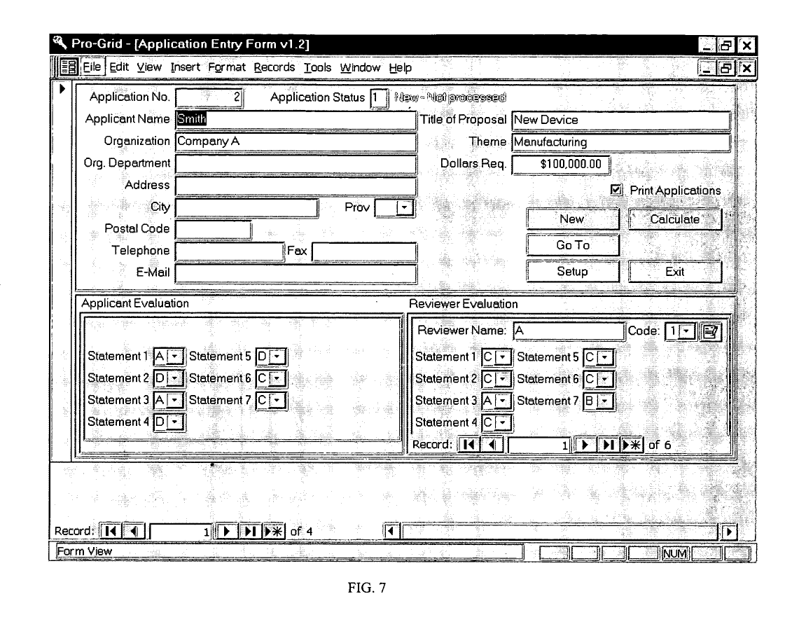

Data collection may be accomplished manually or via computer hardware and software, such as by worldwide web pages or other interface which presents users with performance criteria and receives user-input regarding the extent to which individual statements accurately describe an intangible asset of interest. FIG. 7 provides an example of a user input page that is accessible electronically by a user, either by entry on or downloading from an internet web site or through direct e-mail transfer. In this respect, the form of FIG. 7 may be provided via an HTML form, a database data entry form (such as a Microsoft Access form), or other suitable data entry means.

The form of FIG. 7 provides for the entry of a) identification information concerning the intangible asset, in this case a proposal for funding a project submitted to a venture capital fund, b) the ratings of an applicant, and c) the ratings of five reviewers. In this example, there are seven sets of statements relating to seven performance criteria, with four possible ratings in each ranging from a low performance (A) to a high performance (D).

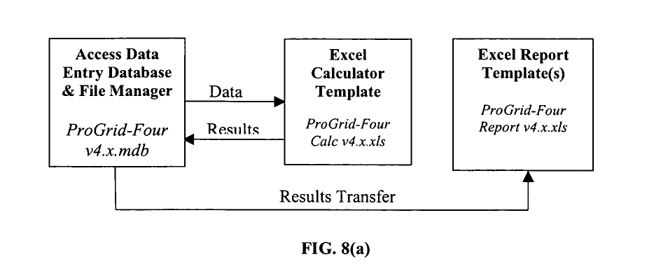

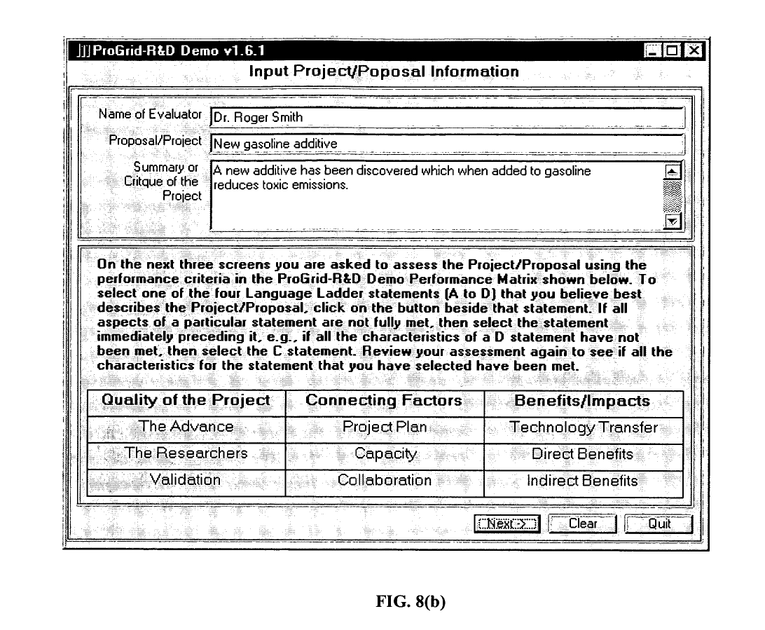

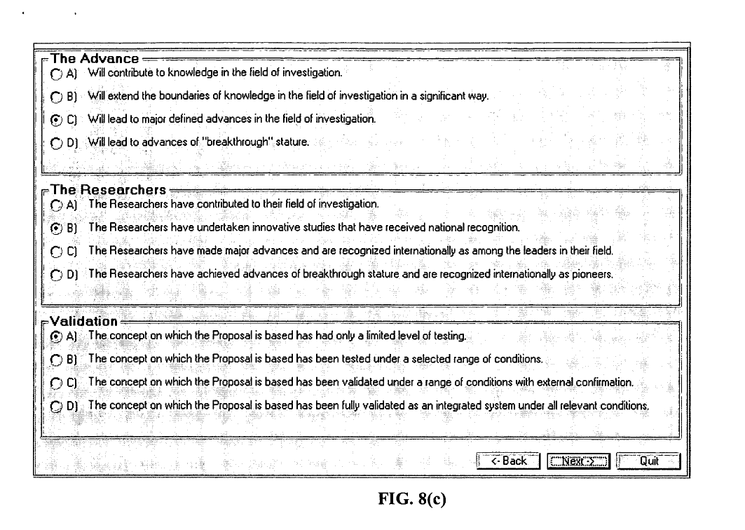

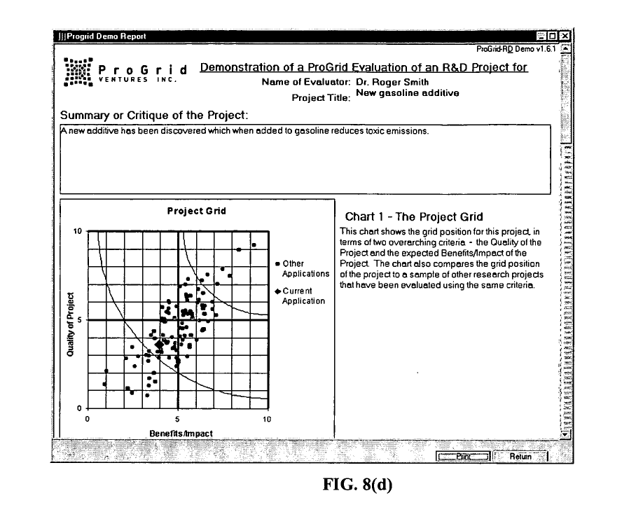

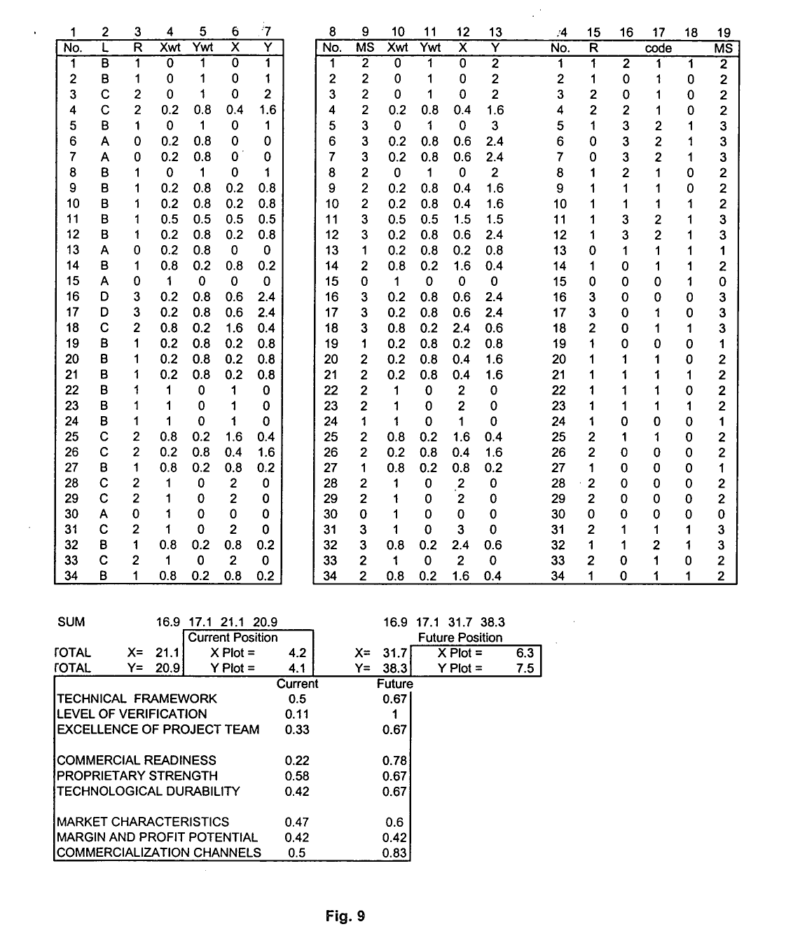

Once the performance criteria data are collected, calculations can be made on the data using computer hardware and software. Such calculations include, e.g., summing of scores, application of axis weighting factors, and generation of data describing a valuation grid and a point thereon. An efficient method of making the calculations is to integrate the three computer software modules as shown in FIG. 8(a). the Access Data Entry Database & File Manager (a more comprehensive form of the embodiment in FIG. 7) provides for the entry of information identifying the applicant, the applicant's self-assessment, and the assessment and comments of the reviewers, for an unlimited number of applications. The Access Data Entry Database & File Manager also opens the Excel Calculator template, transfers the data to the calculator template to initiate the calculations, and transfers the calculated data to the Excel Report template(s). Report files are created and saved.

For on-line Internet applications, a preferred method is to carry out data input, calculations and report generation in a single computer program, using for example Visual Basic programming language. The following example shows the use of the method for evaluating scientific projects submitted to a funding organization. FIG. 8(b) shows a first data input screen that is accessed from the web site of the funding organization. This screen records the name, title and summary of the project, and the evaluation matrix being used by the funding agency. FIG. 8(c) shows a screen for recording the evaluations for three of the cells in the evaluation matrix relating to the first independent variable, “Quality of the Project”. FIG. 8(d) (Chart 1) shows a report generated as a result of performing the calculations that were described previously for the example shown in FIG. 3. The comparison and ranking of a number of intangible assets is an important feature of the invention. The report shown in FIG. 8(d) includes an example of the comparison and ranking of projects submitted to the funding agency.

The future value of an intangible asset can be determined by rerunning the calculation using new rating levels, determining through a code in the format x, y, z where x is the number of improvement steps which the asset is likely to achieve if its current position is at the lowest performance level, y is the number of improvement steps that the asset is likely to achieve if its current position is at the next highest performance level, and z is the number of improvement steps the asset is likely to achieve if its current position is at the next highest performance level. The values x, y z are determined by those with experience in the development and commercialization of technology. Once determined, the x, y, z values are kept constant until experience shows a change is appropriate. This procedure will become apparent by inspecting the following example.

FIG. 9 shows the results of a computer calculation of the evaluation of a technology for treating mineral ores to improve their separation. Columns 1, 8, and 14 show the performance criteria number. Column 2 is a letter chosen to represent the performance criteria statement selected by the evaluators (A, B, C, or D). Column 3 transforms the letters into a numerical performance rating (0, 1, 2, or 3). Columns 4 and 5 are the X-axis and Y-axis weight factors. Columns 6 and 7 are the calculated X and Y values for each performance criteria, which are totaled to produce the (X, Y) plotting coordinates. In columns 8 to 13, this procedure is repeated using a maximum performance rating (MS) that is calculated in columns 14 to 19. Column 15 is a repeat of the performance rating (column 3).

The code for calculating the maximum performance rating is shown in columns 16 to 18. Column 19 is the maximum performance rating, which is copied to column 9. As an example of this calculation, the performance rating for criteria 1 is 1. The code in columns 16 to 18 is 2, 1, 1, which means that if the performance rating is 0, the future rating will increase by 2, if the performance rating is 1, it will increase by 1, and if the performance rating is 2, it will increase by 1. Since the performance rating is 1, the maximum performance rating is 1+1=2. At the bottom of FIG. 9, the scores are grouped into performance areas and expressed as a percentage of the highest rating obtainable.

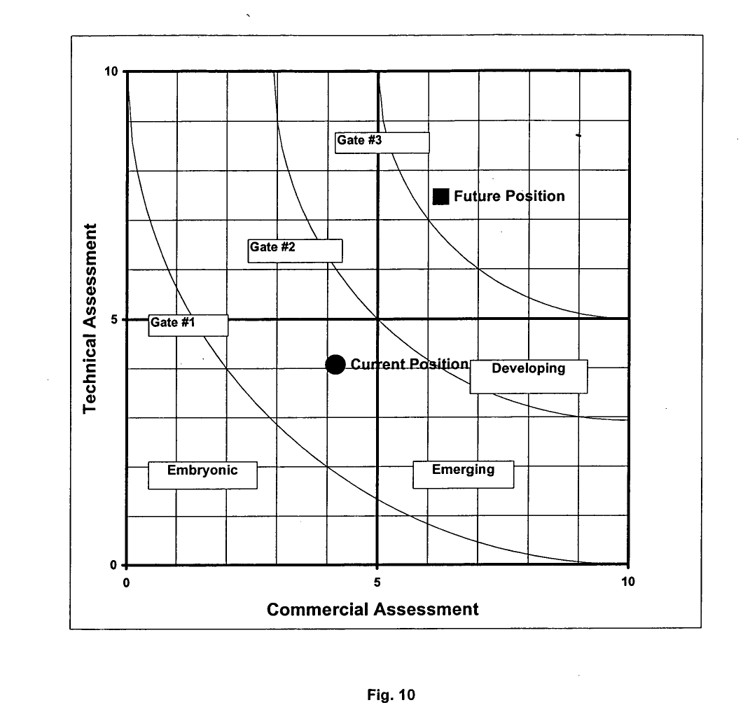

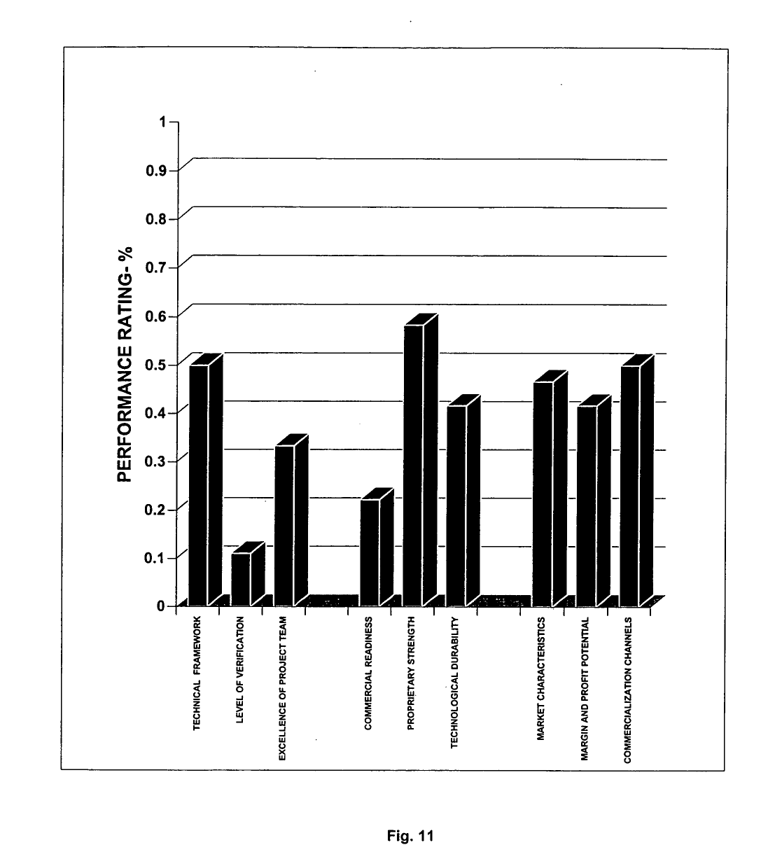

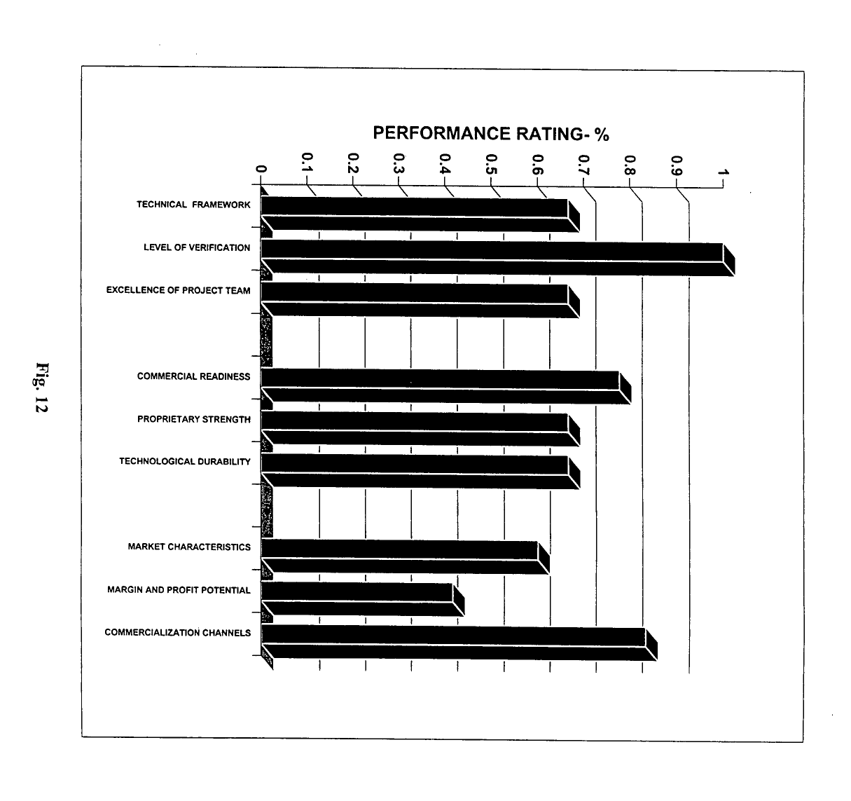

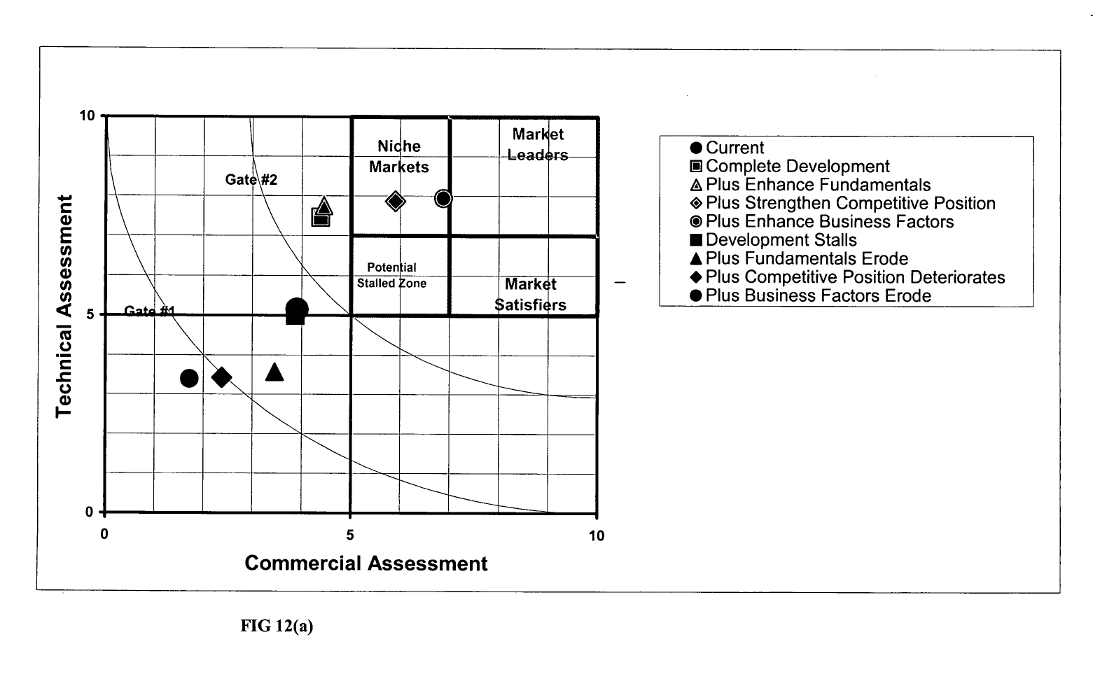

FIGS. 10, 11 and 12 show the current and future chart positions and the current and future ratings for the performance areas. Gate lines are shown in FIG. 10 to separate the chart into zones representing the maturity of the technology. By comparing FIGS. 11 and 12, the venture capital manager is able to identify the areas where improved performance is required and the likelihood that this improvement can be achieved.

It has been found that separating the future state into defined steps provides useful information to help in strategic planning. For example, the route to the desired future state for a technology-based venture can be separated into discrete steps equivalent to the situation that would exist if the following occurred:

1. The current development is completed successfully (e.g., pilot tests are completed);

2. The fundamentals underlying the venture are improved (e.g., patents are approved);

3. The competitive position improves (e.g., potential competitors go bankrupt); and

4. The business factors improve (e.g., regulatory changes assist market introduction).

Each of these situations require one set of x, y, z codes.

FIG. 12(a) shows the results of carrying out the calculations described in FIG. 9 four times, with four sets of x, y, z codes, representing the sequential improvement in the four situations described above, and another four sets of x, y, x codes representing the sequential deterioration in these four situations.

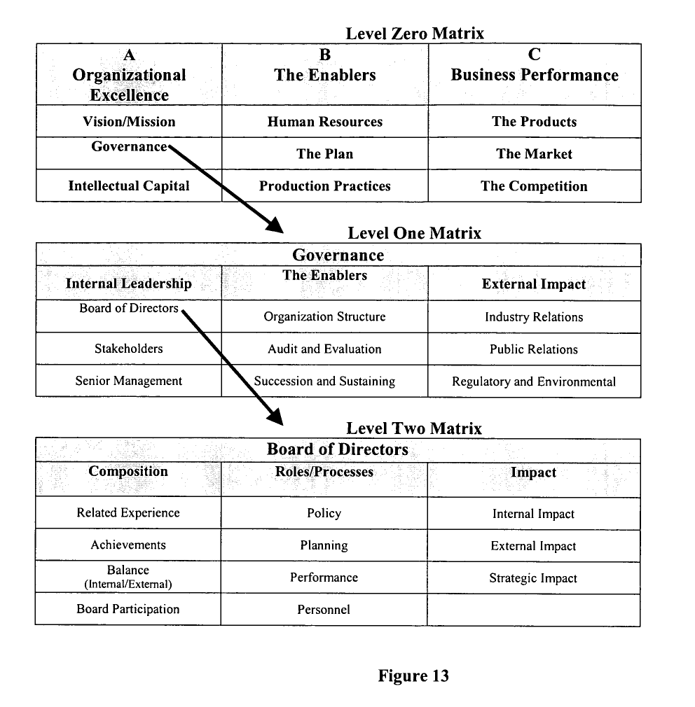

All of the examples described above involve a single matrix of performance areas. For measuring the performance of organizations which have various levels of management and operations, a more rigorous evaluation can be undertaken using the concept of cascading matrices, as shown FIG. 13.

The upper matrix (Level Zero) in FIG. 13 is the same as that shown previously in FIG. 1(a). Each cell in this matrix will have its own underlying matrix, with a set of performance areas. For example the Governance cell links to a nine-cell matrix at Level 1 composed of performance areas that contribute to good governance. One of the latter is a Board of Directors cell that in turn will have its own underlying matrix at Level 2 with a set of performance areas.

If each cell in the Level Zero matrix has an underlying nine-cell matrix (at Level One) and if each of these has another underlying nine-cell matrix (at Level Two), there would be a total of 91 matrices (1 at Level Zero, 9 at Level One and 81 at Level Two). Mathematical relationships among these matrices can be developed to compare and validate the performance of an organization at each level, as described in the following example. (In most cases, it would not be feasible to evaluate the performance of the organization for each of the 91 matrices. However, it is feasible to evaluate an organization at Level Zero and Level One and “drill down” into Level Two where questions are raised at Level Zero and Level One).

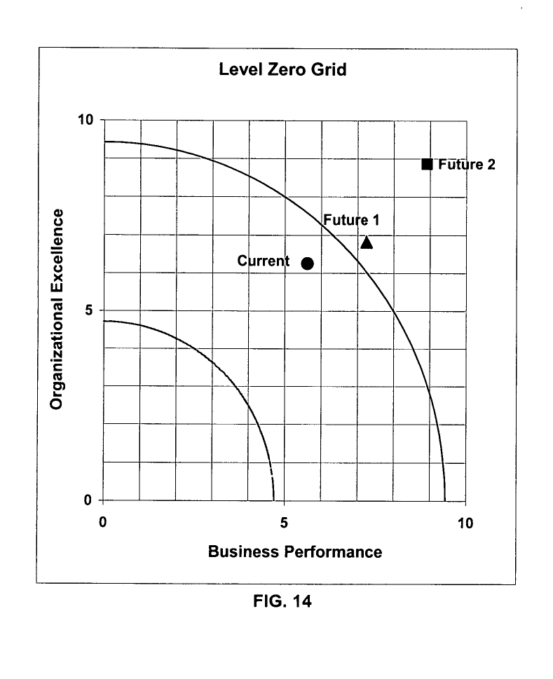

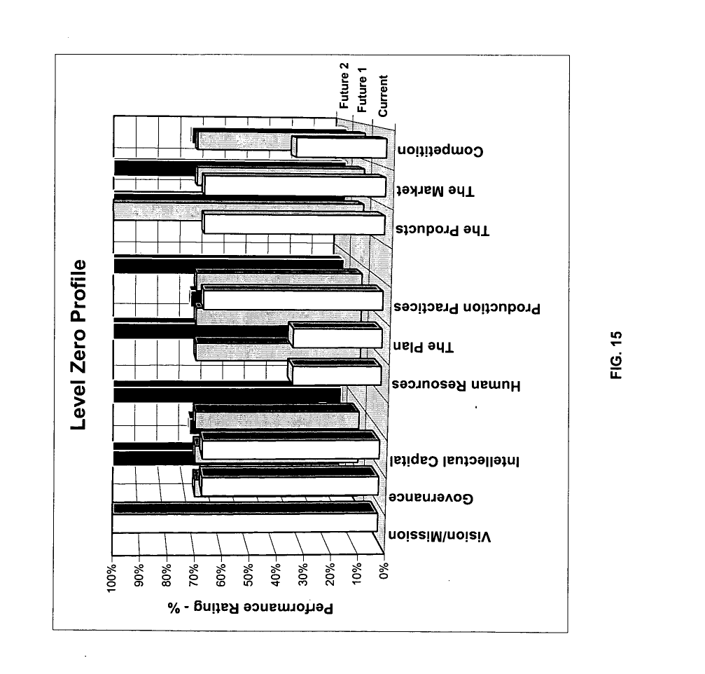

For the Zero level matrix in FIG. 13, performance criteria can be established for each cell in this matrix as explained in the example in FIG. 2. Using a scoring form as illustrated in FIG. 3, an organization can be evaluated to produce the grid chart shown in FIG. 14 and the scores for each performance area as shown in FIG. 15. The future performance of the organization can also be assessed using the procedures shown in FIG. 9. To assist in determining future positions, each future MS is exemplified specifically in the grid chart. For example, Future 1 is the performance level that would be achieved if all planned improvements were put in place, and Future 2 is the performance level that would be required to be a true pacesetter in all areas.

The choice of center for the boundary curves depends whether it is desired to emphasize the distance to travel or the distance traveled. In the case of FIG. 14 the boundary curves are concentric with the point 0,0 rather than the point 10,10 as is FIG. 4(b). The R-value for FIG. 14 is mathematically equal to:

SQRT(X\hat{ }2+Y\hat{ }2)/SQRT(200)

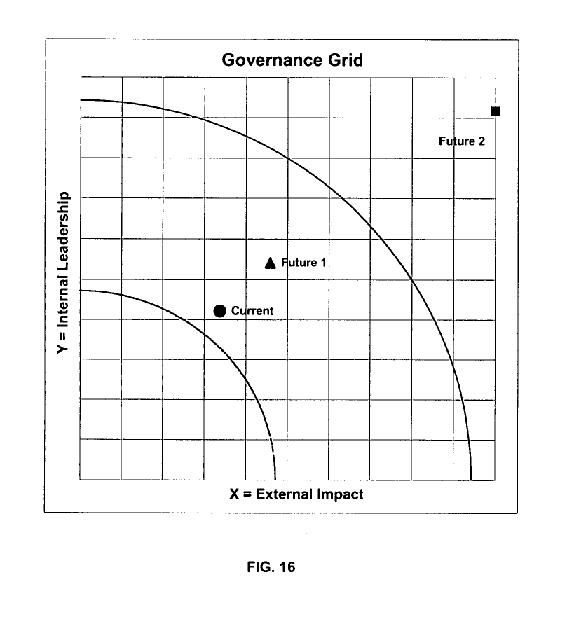

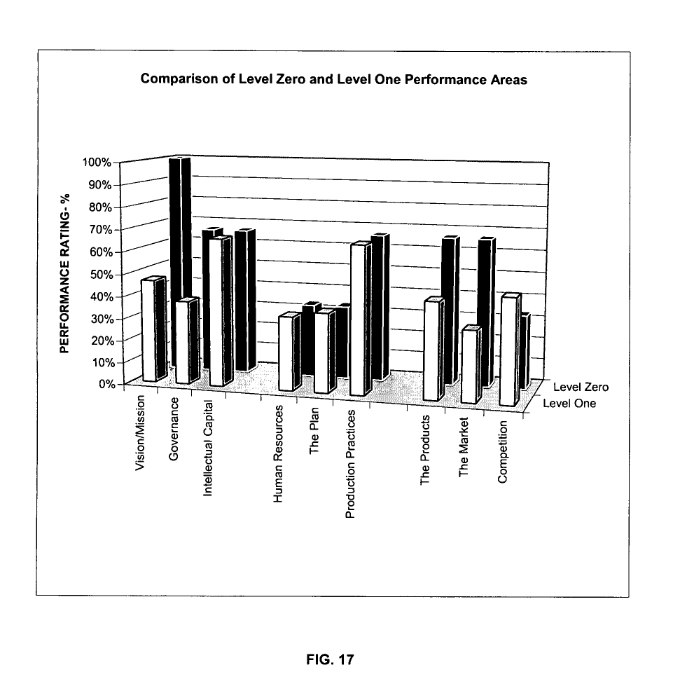

A similar process can be undertaken for the Level One matrices. For example, performance criteria can be established for each cell in the Governance matrix and an organization evaluated to produce the grid chart shown in FIG. 16. The R-value for the Current position in this chart is 38%. When compared with the Governance score for the Level Zero Governance cell of 67%, there is a major disagreement in the Governance performance area as seen at Level Zero compared to Level One. In this particular case, the Board of Directors carried out the Level Zero evaluation and senior management carried out Level One. This suggests that the Board of Directors was not cognizant of the full range of factors involved in good governance. The comparison of all Level Zero and Level One performance areas is shown in FIG. 17.

This leads to the first principle in the mathematics of cascading matrices: the R-value of a cell in a matrix can be compared and validated against the related performance area score in the next highest level matrix.

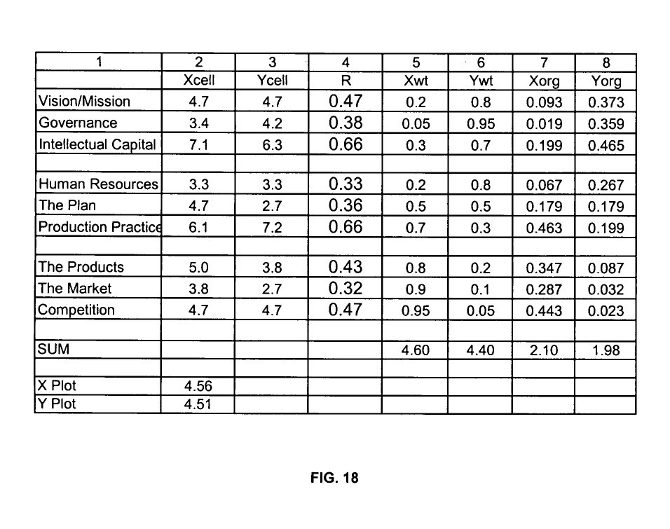

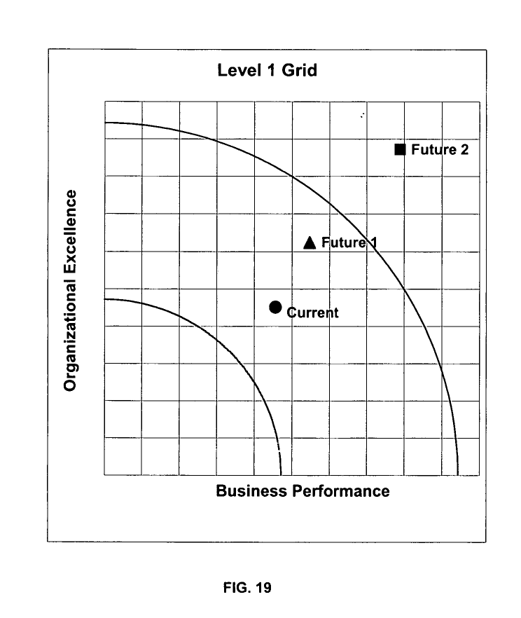

Once each of the Level One matrices has been evaluated as described above, the individual R-values can be aggregated to produce a grid chart showing the overall performance of the organization as seen at Level One. The aggregation calculation is given in FIG. 18. Column 1 lists the titles of the nine performance areas at Level Zero. Columns 2 and 3 are the X and Y values calculated for the each of the Level One grids. Column 4 is the calculated R-value. Columns 5 and 6 are the X and Y-axis weights, reflecting the contribution of each performance area to the two independent variables. These are determined by an examination of the performance criteria statements. Columns 7 and 8 are the X and Y value contributions. The X-plot is determined as the X-axis contribution divided by the maximum X-values available (2.10 divided by 4.60, times 10 to express the value on a ten point grid). The Y-plot is determined similarly. The resulting chart is shown in FIG. 19.

The second principle in the mathematics of cascading matrices: the R-values of the matrices at one level can be aggregated to compare and validate the grid chart at the next highest level. In this example, the X and Y values for the Level Zero grid are 5.62, 6.25 and for the Level One grid are 4.56, 4.51. The specific performance areas underlying these differences are shown in FIG. 17.

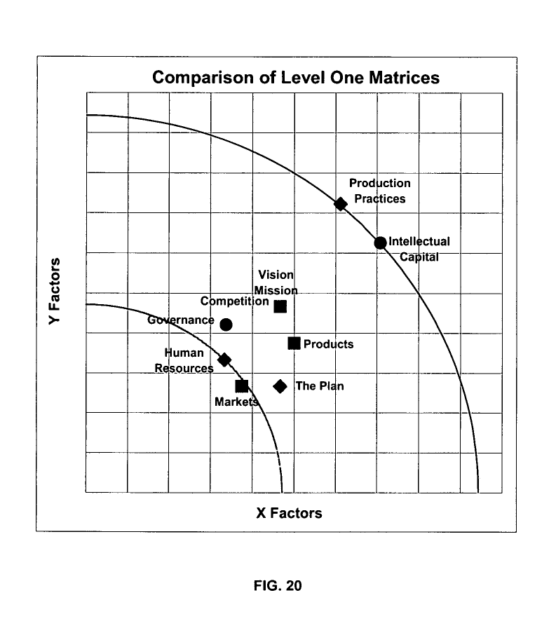

The above procedure shows how to compare the overall performance of an organization as measured at a high strategic level and as measured at a more detailed operational level. It is also possible to compare the contributions that each lower level matrix is making in meeting its own internal objectives, by plotting the X and Y factors of each matrix as shown in FIG. 20. The Governance value is 3.4, 4.2 as shown previously in FIG. 16. The other points in FIG. 20 are calculated in a similar fashion.

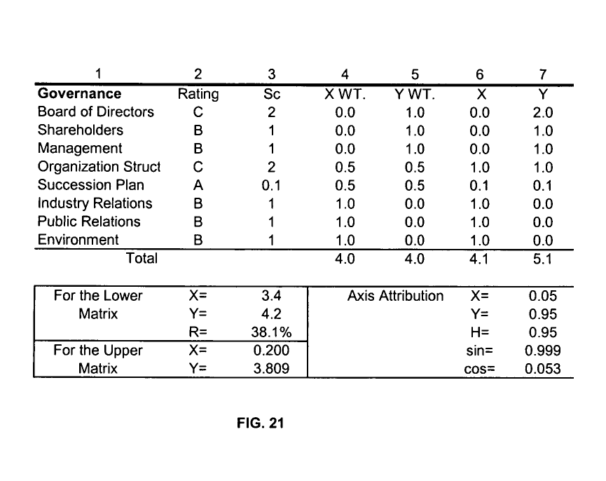

It is also desirable to compare the contribution of each lower level matrix to the independent first and second variables of the Level Zero grid. This requires that the R-value of the lower level matrix be apportioned to these first and second variables, as shown in FIG. 21. The names of the performance areas in the Governance matrix are in Column 1. The scores in letter and numeric form are in Column 2 and 3. The X-axis and Y-axis weights are in Column 4 and 5. The X-axis and Y-axis contributions are in Columns 6 and 7. The X and Y values for the Governance Grid are shown in the lower part of FIG. 21 and are calculated as described previously in FIG. 9, and plotted in FIG. 16. However, these X and Y values only apply to the independent first and second variables of the Governance grid. In order to plot these against the independent first and second variables of the Level Zero grid requires that the R-value vector be rotated by the angle made by the X and Y contributions to this latter matrix. In this example, the Governance matrix largely affects the Organizational Excellence axis with a Y weighting of 0.95 and an X-axis weighting of 0.05. (These weighting values are preferably assigned by experienced organization managers by examining the specific performance areas in the Governance matrix). The sine and cos of this angle can be used to rotate the governance grid axis as follows:

X=R cos(angle)=0.381(0.053)(10)=0.2

Y=R sin(angle)=0.381(0.999)(10)=3.8

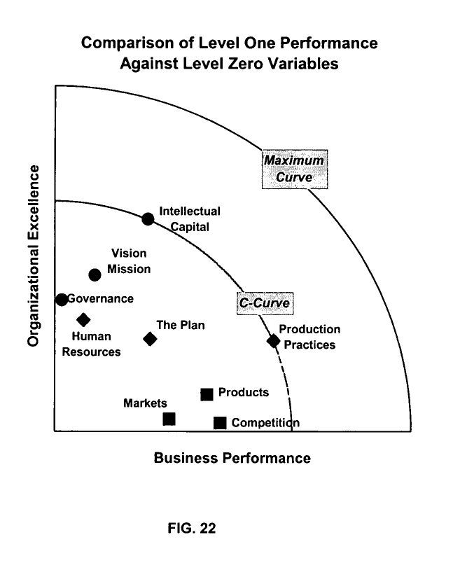

These X and Y values with respect to the Level Zero first and second variables are plotted on a radial chart, as shown in FIG. 22.

In the case where the lower level grid has the identical axes as the Level Zero grid, it is not necessary to arbitrarily assign axis-weighting factors. For example, if the axes for the Governance matrix in FIG. 22 had been the same as for the Level Zero matrix, the sum of the available X and Y values (4.0 and 4.0 in each case) will determine the axis weighting factors. In this case, the angle would be 45 degrees and the sine and cos would be 0.707. These values would then be used in the calculations in FIG. 21.

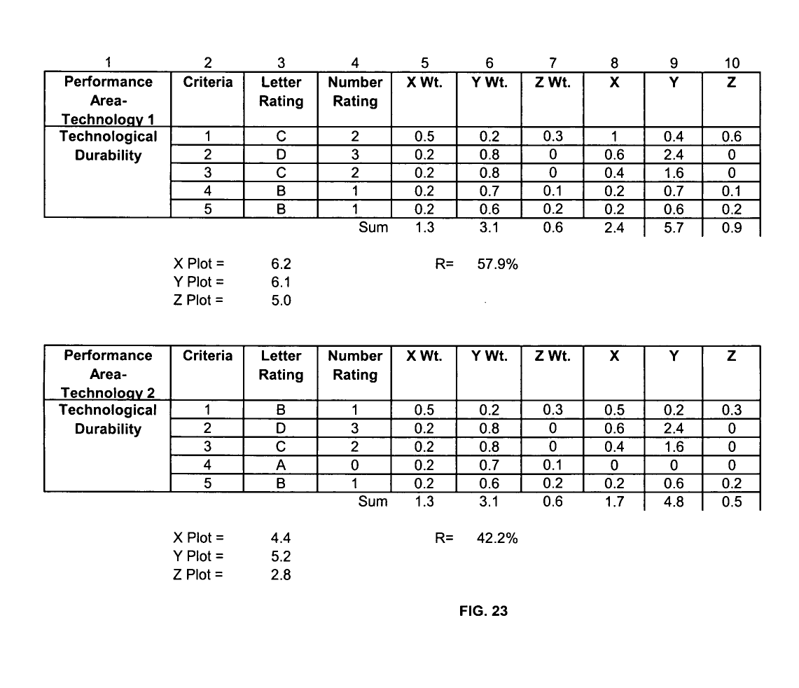

In all of the examples described above, only two independent variables are involved. However, as noted previously, it will be appreciated by those skilled in the art that more than two can be utilized. FIG. 23 shows the calculations where three independent variables are required to properly determine value of new technologies. In this example, two new technologies are evaluated with respect to three independent variables, commercial strength (X-axis), technical strength (Y-axis) and societal acceptability (Z-axis). The Performance Area is shown in Column 1. The Criteria number, letter rating and number rating are shown in Columns 2, 3 and 4. The X-axis, Y-axis and Z-axis weights are shown in Columns 5, 6 and 7. The X, Y and Z values are determined as described in FIG. 3 and shown in Columns 8, 9 and 10. The X, Y and Z plot positions are calculated by an analogous procedure to that shown in FIG. 3. For example, the X plot-is equal to (2.4 times 10) divided by (1.3 times 3), equal to 6.2.

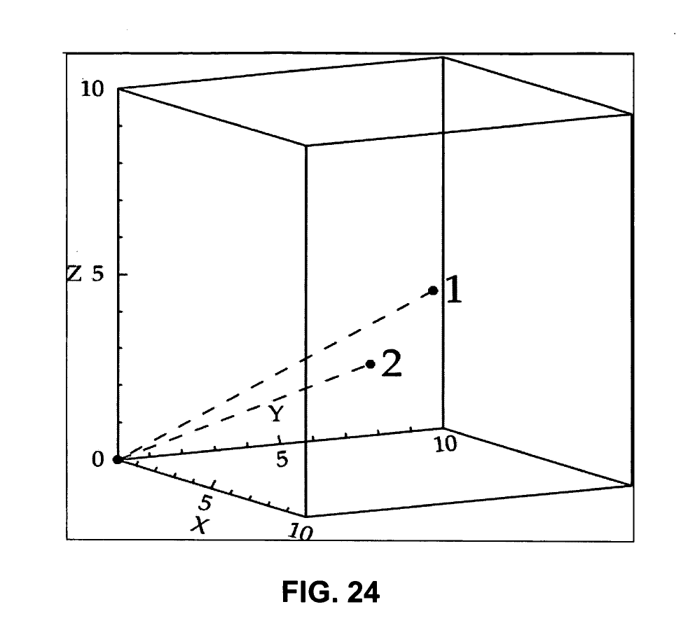

FIG. 24 shows the three-dimensional plot of these two technologies having coordinates of X=6.2, Y=6.1 and Z=5.0 (Technology 1) and X=4.4 Y=5.2 and Z=2.8 (Technology 2). The R-values for these two technologies are 57.9% and 38.0% respectively, calculated from the following equation:

(SQRT(X\hat{ }2+Y\hat{ }2+Z\hat{ }2))/SQRT(300)

These R values represent the distance from the lower corner of the cube (0, 0, 0) as a percentage of the distance from 0, 0, 0 to 10, 10, 10.

More than three independent variables can be used if required, using similar mathematical techniques. In such cases, graphical presentation of the hypercube would not be possible. However, the relative values of organizations or intangible assets would be determined by comparison of their R-values, calculated from the following equation:

(SQRT(X₁\hat{ }2+X₂\hat{ }2+X₃\hat{ }2+ . . . Xₙ\hat{ }2)/SQRT(100*n)

Once a chart such as one shown in FIGS. 4(b), 10, 14, or 22 is created, the final step is to interpret the results for purposes of making decisions regarding the value of the intangible asset or organization. Such decisions include, e.g., whether to invest capital in a technology, how to develop a strategic plan to optimize an asset's future value, which programs to fund among competing programs within an organization, and whether an organization has met a level of achievement set forth in a mission established by its owners.

Depending upon which evaluators have undertaken the analysis, various conclusions can be drawn from the results, and those conclusions can be of importance to various stakeholders. Regarding the four particular types of organizations/assets described herein (i.e., a company, a research and development organization, a university, and a technology), the process of the invention provides quantitative information in at least the following areas.

With respect to companies, managers of companies are expected to develop a first-rate organization that meets or exceeds industry standards of excellence and, at the same time, ensure long-term survival of the company by developing new business opportunities to replace maturing and aging products and markets. The process of the invention quantitatively identifies how well the company has met these two objectives.

With respect to research and development organizations, the managers of such organizations must establish a first-rate R&D management system but must also ensure that the organization contributes significantly to the success of its corporate and public sector clients. The process of the invention will identify how successful the managers have been in meeting these objectives.

With respect to universities, such institutions differ in their respective emphasis on research and teaching. The process of the invention makes it possible to measure their performance with respect to these sometimes-competing responsibilities and to achieve the balance desired by the Board of Governors.

With respect to technologies, technology commercialization is made difficult by the high risks involved in introducing new ideas into the marketplace. The process of the invention provides a measurement of the technical and commercial readiness of new technologies and enables investors to choose between competing proposals.

While the invention has been particularly shown and described with reference to a preferred embodiment thereof, it will be understood by those skilled in the art that various changes in form and details may be made therein without departing from the spirit and scope of the invention. For example, a system having four statements per performance criteria has been illustrated above. However, in some applications, a different number of statements my be desired for either simplicity or enhanced rigor.

The embodiments of the invention in which an exclusive property or privilege is claimed are defined as follows:

1. A method of manufacturing a chart reflecting the value of an intangible asset of interest, comprising the steps of:
establishing a first independent variable, a second independent variable, and a third independent variable related to the value of the specific intangible asset of interest;
establishing a matrix of performance areas;
establishing a series of performance criteria statements for each performance area probative of the value of the first, second, and third independent variables;
scoring each of said performance criteria statements to produce a plurality of scores which reflect the applicability of the performance criteria statements to the specific intangible asset of interest;
storing the plurality of scores obtained by the scoring step in an electronic database;
using a computing apparatus to read and sum the stored plurality of scores to generate first, second, and third total scores based upon the extent to which individual statements accurately describe the intangible asset of interest;
using a printer to transform physical media into a chart by physically plotting on the media a first axis relating to the first independent variable, a second axis relating to the second independent variable, and a third axis relating to the third independent variable;
using a printer to physically plot a point on the chart, the point being located at coordinates corresponding to the first, second, and third total scores, respectively; and
using the chart in making at least one decision regarding the value of the intangible asset of interest.

2. The method of 1, wherein the first independent variable relates to commercial strength, the second independent variable relates to technical strength, and the third independent variable relates to societal acceptability.

3. A method of manufacturing a chart reflecting the value of an intangible asset of interest, comprising the steps of:
establishing a first independent variable and a second independent variable related to the value of the specific intangible asset of interest;
establishing a matrix of performance areas, comprising the steps of:
establishing three columns in the matrix, wherein a first column comprises performance areas regarding internal factors, a second column comprises performance areas regarding external factors, and a third column comprises performance areas that link the internal and external factors;
establishing a series of performance criteria statements for each performance area probative of the value of the first and second independent variables;
scoring each of said performance criteria statements to produce a plurality of scores which reflect the applicability of the performance criteria statements to the specific intangible asset of interest;
storing the plurality of scores obtained by the scoring step in an electronic database;
using a computing apparatus to read and sum the stored plurality of scores to generate first and second total scores based upon the extent to which individual statements accurately describe the intangible asset of interest;
using a printer to transform physical media into a chart by physically plotting on the media a first axis relating to the first independent variable and a second axis relating to the second independent variable;
using a printer to physically plot a point on the chart, the point being located at coordinates corresponding to the first and second total scores, respectively; and
using the chart in making at least one decision regarding the value of the intangible asset of interest.

4. A method of manufacturing a chart for determining the future value of an intangible asset of interest, comprising the steps of:
establishing a first independent variable and a second independent variable related to the value of the specific intangible asset of interest;
establishing a matrix of performance areas;
establishing a series of performance criteria statements for each performance area probative of the value of the first and second independent variables;
scoring each of said performance criteria statements to produce a plurality of scores which reflect the applicability of the performance criteria statements to the specific intangible asset of interest;
storing the plurality of scores obtained by the scoring step in an electronic database;
using a computing apparatus to read and sum the stored plurality of scores to generate first and second total scores based upon the extent to which individual statements accurately describe the intangible asset of interest;
using a printer to transform physical media into a chart by physically plotting on the media a first axis relating to the first independent variable and a second axis relating to the second independent variable;
using a printer to physically plot a point on the chart, the point being located at coordinates corresponding to the first and second total scores, respectively;
determining values for a code having a first value, a second value, and a third value, wherein the first value is the number of improvement steps the asset is likely to achieve if the current position is at a lowest performance level, the second value is the number of improvement steps the asset is likely to achieve if the current position is at a level higher than the lowest performance level, and the third value is the number of improvement steps the asset is likely to achieve if the current position is at two levels higher than the lowest performance level;
determining a maximum performance rating by adding a performance rating value to the first value, second value, or third value of the code;
calculating a x-coordinate, corresponding to the first axis, and a y-coordinate, corresponding to the second axis, of the future value utilizing the maximum performance rating; and
plotting the x and y coordinates of the future value on the chart.

5. The method of claim 4, wherein the values for the first value, second value, and third value are held constant.

6. The method of claim 4, wherein a desired future value is achieved through the occurrence of at least one of the following:
the current development is completed, the fundamentals underlying the venture improve, the competitive position improves, and the business factors improve,
wherein each occurrence requires a code having a first value, second value, and third value.

7. The method of claim 6, wherein the future value may be plotted representing an improvement or deterioration in at least one of the occurrences.

8. A method of manufacturing a chart reflecting the value of an intangible asset of interest, comprising the steps of:
establishing a first independent variable and a second independent variable related to the value of the specific intangible asset of interest;
establishing a matrix of performance areas;
establishing a series of performance criteria statements for each performance area probative of the value of the first and second independent variables;
scoring each of said performance criteria statements to produce a plurality of scores which reflect the applicability of the performance criteria statements to the specific intangible asset of interest;
storing the plurality of scores obtained by the scoring step in an electronic database;
using a computing apparatus to read and sum the stored plurality of scores to generate first and second total scores based upon the extent to which individual statements accurately describe the intangible asset of interest;
using a printer to transform physical media into a chart by physically plotting on the media a first axis relating to the first independent variable and a second axis relating to the second independent variable;
using a printer to physically plot a point on the chart, the point being located at coordinates corresponding to the first and second total scores, respectively; and
using the chart in making at least one decision regarding the value of the intangible asset of interest.

9. The method of claim 8, further comprising the steps of:
establishing an underlying matrix of performance areas for each cell in the matrix of performance areas;
establishing primary and secondary independent variables related to the value of a cell in the matrix of performance areas;
establishing a series of underlying matrix performance criteria statements for each underlying matrix performance area probative of the value of the primary and secondary independent variables;
scoring each of the underlying matrix performance criteria statements to produce a plurality of underlying scores which reflect the applicability of the performance criteria statements to the specific intangible asset of interest;
storing the plurality of underlying scores obtained by said scoring step in an electronic database;
using a computing apparatus to read and sum the stored plurality of underlying scores to generate primary and secondary total scores based upon the extent to which individual statements accurately describe said intangible asset of interest;
using a printer to transform physical media into a chart by physically plotting on the media a primary axis relating to the primary variable and a secondary axis relating to the secondary variable;
using a printer to physically plot a point on said chart, said point being located at coordinates corresponding to the primary and secondary total scores, respectively; and
comparing the coordinates of the underlying matrix with the scores of the related performance area in the matrix.

10. The method of claim 9, wherein the coordinates of the underlying matrix are expressed as an R factor percentage.

11. The method of claim 9, wherein the cells of the underlying matrix have a second underlying matrix, such that performance of the upper level matrix may be measured at the more detailed underlying matrices.

12. The method of claim 9, further comprising the steps of:
expressing the coordinates of all underlying matrices as R factor percentages;
calculating first and second total scores for the matrix using the R factor; percentages as the plurality of scores in accordance with claim 8; and,
comparing the new first and second total scores of the matrix with those obtained from the procedures of claim 8.

13. The method of claim 8, further comprising the steps of:
entering as data of least one assessment of the performance criteria;
opening a calculator template;
transferring the data to the calculator template, wherein the calculator template performs calculations on the data to create calculated data;
transferring the calculated data from the calculator template to a report template; and
creating a report file for the calculation data.

14. The method of claim 13, wherein the calculations comprise summing of scores, applying axis weighting factors, or generating data describing a valuation grid and a point on the valuation grid.

15. The method of claim 11, further comprising the step of saving the report file.
